(19) United States
(12) Patent Application Publication
(10) Pub. No.: US 2009/0194034 A1
(43) Pub. Date: Aug. 6, 2009

(54) TEAT FOAM RING

(75) Inventor: Daniel R. Jacques, Caledonia, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: INNOVATIVE CLEANING EQUIPMENT, INC., Grand Rapids, MI (US)

(21) Appl. No.: 12/421,734

(22) Filed: Apr. 10, 2009

Related U.S. Application Data
(63) Continuation of application No. 11/743,399, filed on May 2, 2007.

(51) Int. Cl. A01J 7/04

(52) U.S. Cl. 119/670

(57) ABSTRACT

A teat foam ring connected to a supply of pressurized cleaning solution and a supply of pressurized air. The teat foam ring includes a cleaning solution inlet and defines a cleaning solution channel and an extrusion slot. Cleaning solution and compressed air flow into the ring through the cleaning solution inlet and into a cleaning solution channel. The cleaning solution is expelled from the ring through the extrusion slot as a foam. The extrusion slot extends upwardly and inwardly so that the foam forms a cone supported on an upper surface of the ring over the central opening in the ring. The teat foam ring may include or be connected to a mixing chamber for transforming the cleaning solution and the compressed gas into a foam. The mixing chamber may be defined within the inlet of the teat foam ring. A mixing medium may be located in the mixing chamber.

This application is a continuation of U.S. application Ser. No. 11/743,399, which was filed on May 2, 2007, by Daniel R. Jacques.

### BACKGROUND OF THE INVENTION

The present invention relates to an apparatus used in the harvesting of milk from milk producing animals and, more particularly, to an apparatus for disinfecting and otherwise cleaning the teats of a milk producing animal prior to the harvesting of that animal's milk for human consumption.

Preparation of the teats prior to milking consumes a significant portion of the overall milking process. Proper sanitation of the teat prior to milking is generally required by law and is important to both reduce the bacteria content of the subsequently harvested milk as well as prevent teat infection. Teat infections are costly to the dairy operator causing decreased milk production and in some cases may even lead to the death of the cow.

Various methods of cleaning the teats prior to milking are known in the art. One of the most basic methods is cleaning the teat using a sponge or cloth. A more advanced method involves dipping the teat into a cup of cleaning solution. An appropriate amount of cleaning solution is dispensed into the cup, the soiled udder is dipped into the cleaning solution in the cup, the expended cleaning solution is discarded, and the process cycles again for subsequent teats. This method can be responsible for spreading disease from teat to teat after a diseased teat is inserted into the cup, contaminates the cup, and the contaminated cup is used on subsequent teats. Further, for effective disinfecting, the teat needs to remain in contact with the cleaning solution a sufficient length of time. Because liquid cleaning solution is prone to quickly dripping away from the udder, the cup needs to be held in place under the udder the requisite amount of time for disinfecting.

As a result of these disadvantages, spray rings were developed to clean teats. A ring sized appropriately to surround the teat is attached to a pressurized supply of cleaning solution. The ring has several spray nozzles distributed around the interior circumferential surface of the ring. As the teat is inserted into the ring, these nozzles spray liquid cleaning solution onto the teat. This method reduces the risk of spreading contamination among the herd because the teat does not come into contact with a contaminated cup, and each teat is exposed only to fresh cleaning solution. However, this method can be ineffective because the liquid cleaning solution has a tendency to drip away from the teat before the teat is sufficiently disinfected. This method can also be responsible for wasted cleaning solution because the transparent cleaning solution provides no indication of which areas of the teat have been sprayed, and, as a result, the operator sprays excessively to ensure all portions of the teat are covered.

### SUMMARY OF THE INVENTION

The aforementioned problems are overcome by the present invention wherein a teat foam ring is provided for applying a cleaning solution to teats as a foam. In one embodiment, the ring defines a cleaning solution inlet, a cleaning solution channel for routing the cleaning solution within the ring and an extrusion slot for expelling the cleaning solution in foam form.

In one embodiment, the ring includes a mixing chamber to provide a space for combining cleaning solution and pressurized air to produce foam. The mixing chamber may be defined within the cleaning solution inlet. The ring may also include a mixing medium to facilitate mixing of the cleaning solution with pressurized air. The mixing medium may be located in the inlet; in which case, pressurized cleaning solution is transformed into foam as the solution enters the ring at the inlet passing through the mixing medium. In another embodiment, the mixing chamber may be external to the ring such that the cleaning solution and pressurized air are delivered to the ring already in foam form.

In one embodiment, the ring is attached to a flow controller, such as a conventional, manually-actuated spray valve. A supply line is in fluid communication with the flow controller and a pressurized tank containing the cleaning solution; the supply line delivers pressurized cleaning solution to the flow controller.

In another embodiment, the flow controller or the ring is in fluid communication with both a compressed air supply line and a liquid cleaning solution supply line. The compressed air supply line is connected either to the headspace of a pressurized tank containing cleaning solution or alternatively to some other supply of compressed gas such as an air compressor. The liquid cleaning solution supply line is connected to a supply of cleaning solution. The two supply lines deliver compressed air and liquid cleaning solution separately either to the flow controller or the ring. The compressed air and liquid cleaning solution may combine in either the flow controller or in the inlet of the ring to form foam.

In one embodiment, the teat foam ring is operated in conjunction with a portable sprayer unit such as are widely known in the art. The operator travels from teat to teat with the sprayer containing a pressurized supply of liquid cleaning solution and the teat foam ring operatively attached to the portable sprayer. In another embodiment, the teat foam ring is operated in conjunction with a commercial dairy teat cleaning sprayer unit. Such a unit may have either a centralized pressurized supply tank filled with cleaning solution that supplies pressurized cleaning solution to multiple teat foam ring units located throughout the milking parlor or segregated supplies of liquid cleaning solution and compressed gas.

In one embodiment, the ring defines an extrusion slot on the top surface of the ring. The slot may angle upward and inward from the cleaning solution channel housed in the interior of the ring toward a point elevated above the center of the ring. The slot expels the effluent from the ring at a trajectory that causes the foam to form a cone of foam supported by the top surface of the ring. In one embodiment, the slot circles the complete circumference of the ring. In another embodiment, the slot may be discontinuous over one or more sections of the ring to impart the desired characteristics into the foam being expelled from the ring.

In use, the teat to be cleaned may be inserted into the ring through the cone of foam. As the ring is pulled down off the teat, the foam clings to the teat, and the teat will be substantially covered in cleaning solution foam. The cleaning solution's foam consistency will cause the foam to remain in contact with the teat for a longer duration of time before it drips away than liquid solution would, thereby increasing the efficacy of the disinfecting using foam. Fresh foam is extruded prior to the next teat being inserted into the ring thereby minimizing any risk of cross-teat contamination.

The present invention provides an efficient and effective method for cleaning teats of milk producing animals prior to milk extraction. Use of the teat foam ring minimizes waste and increases efficacy of disinfecting because the opaque foam expelled from the ring provides a visible indication that the entire teat has been covered with cleaning solution eliminating the need to spray excessively to insure all areas of the teat have been covered. This is important because any area of the teat that does not come into contact with cleaning solution will not be disinfected. Further, the current invention is quicker than the prior art method using a liquid filled dipping cup because the ring can be immediately removed from the teat. Unlike liquid solutions, the foam solution clings to the teat an extended period of time—for up to 10 minutes in some applications—after the foam is applied providing improved disinfecting of the teat. Additionally, because only fresh foam comes into contact with each teat, the likelihood of cross-teat contamination is lessened by use of the teat foam ring instead of the dipping cup method.

These and other objects, advantages, and features of the invention will be readily understood and appreciated by reference to the detailed description of the current embodiment and the drawings.

### BRIEF DESCRIPTION OF THE DRAWINGS

FIG. 1 is a perspective of the assembled teat foam ring.

FIG. 2 is a cross-section of the assembled teat foam ring taken along line 2-2 of FIG. 1.

FIG. 3 is a top view of the assembled teat foam ring.

FIG. 4 is an exploded perspective view of the unassembled teat foam ring showing the upper ring component above the lower ring component.

FIG. 5 is a representation of operation of the teat foam ring.

FIG. 6 is a schematic diagram of a system utilizing the teat foam ring.

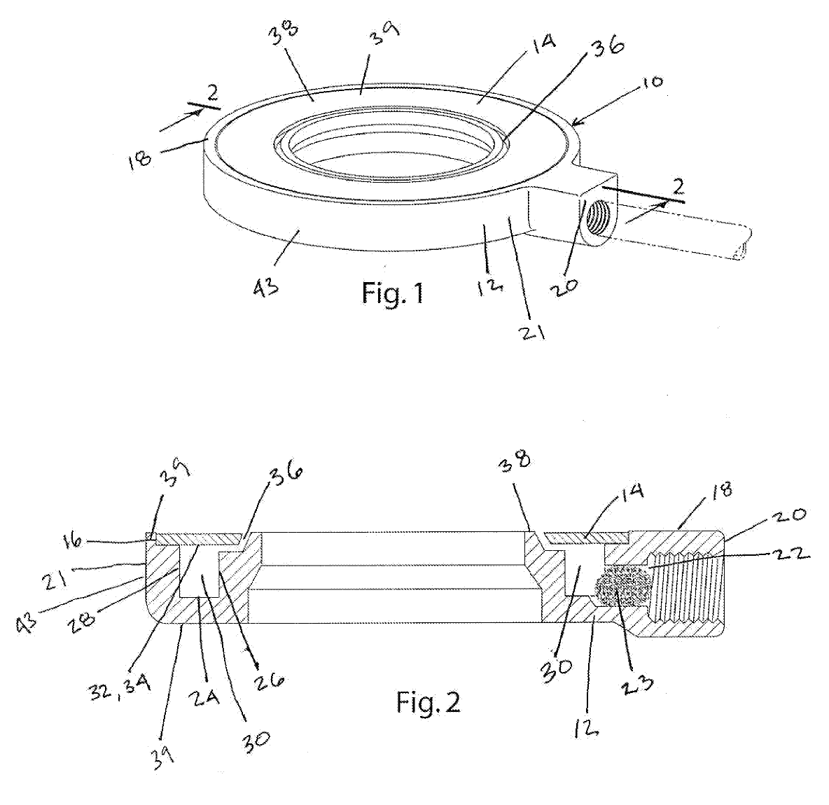

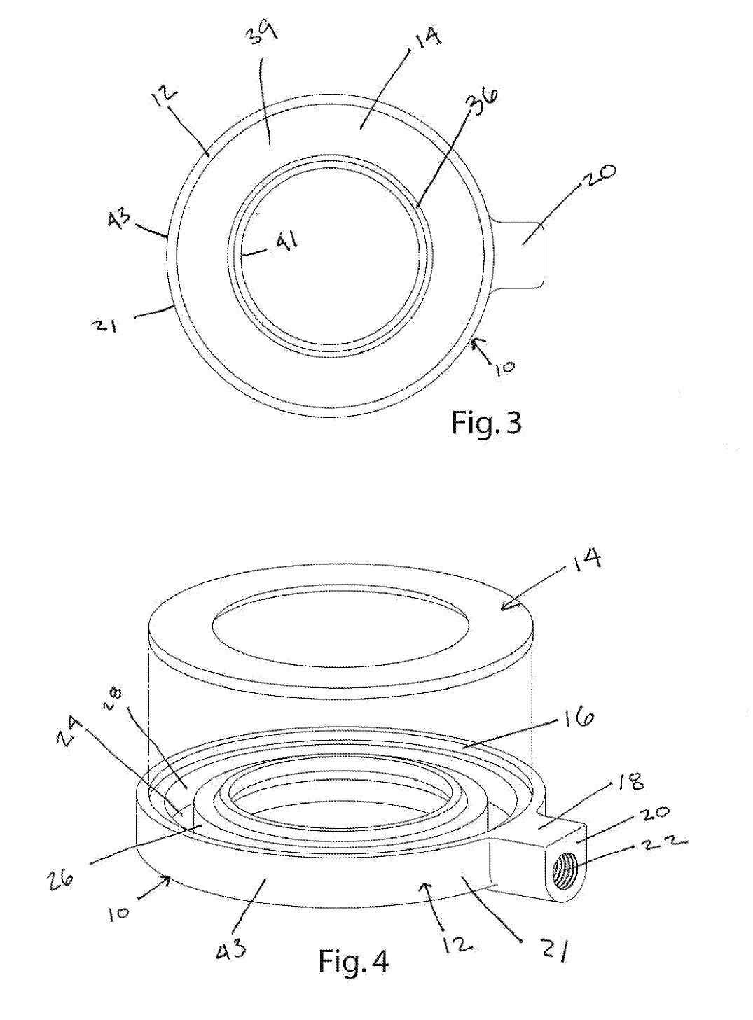

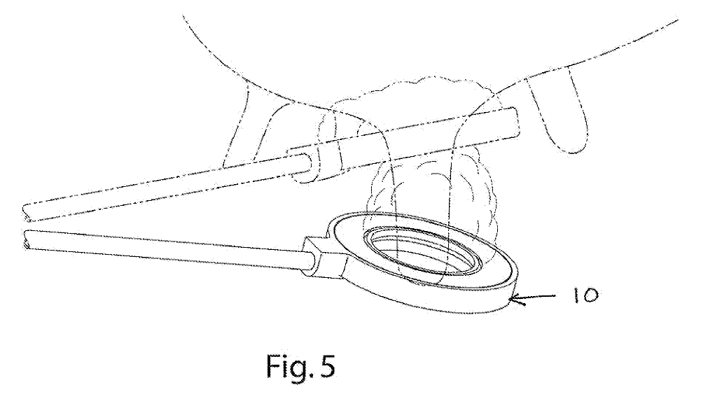

### DESCRIPTION OF THE CURRENT EMBODIMENT

A teat foam ring in accordance with an embodiment of the invention is illustrated in the drawings and generally designated 10. The teat foam ring 10 generally includes a cleaning solution inlet 22, a cleaning solution channel 30 and an extrusion slot 36. The teat foam ring 10 may be connected to a supply of pressurized cleaning solution 42 and a supply of compressed gas 46. In use, the cleaning solution and pressurized air combine to produce effluent that is discharged from the teat foam ring 10 through the extrusion slot 36. The present invention is described in connection with the construction of a specific teat foam ring. However, this particular foam ring 10 is merely exemplary. The present invention is well suited for use in a variety of alternative constructions capable of discharging a teat cleaning solution in a foam form.

In the illustrated embodiment, the teat foam ring 10 has a bottom ring component 12 and an upper ring component 14. Both of these components can be made from stainless steel, plastic, or any other material as would provide suitable performance. In the illustrated embodiment, both the upper ring component 14 and bottom ring component 12 are cast and then machined from stainless steel. Machining is utilized in the illustrated embodiment to accomplish the tight angles and narrow tolerances present in this embodiment, but machining is not strictly necessary.

In the illustrated embodiment, the bottom ring component 12 includes a retaining ledge 16 in the upper surface 18 of the bottom ring component 12. The retaining ledge 16 is sized to receive and retain the upper ring component 14 using a press fit mechanism. The two components may, however, be connected using other techniques and apparatus.

In the illustrated embodiment, the bottom ring component 12 also defines a fitting 20 adapted to connect the teat foam ring 10 to a supply of pressurized cleaning solution 42 and compressed gas 46. Although shown extending from the outer circumferential surface 21, the fitting 20 may be located anywhere on the ring 10. The fitting 20 may utilize any connection mechanism commonly known in the art such as flanges, a press fit or a threaded housing. The fitting 20 defines a cleaning solution inlet 22 that is the point at which the cleaning solution enters the teat foam ring 10. Although connectable to essentially any supply of pressurized cleaning solution 42 and compressed gas 46, the teat foam ring 10 may be connected to the outlet of a flow controller. For example, the teat foam ring 10 may be mounted to the outlet of one of the conventional flow controllers shown in the U.S. Publication No. 2004/0069817 A1, which is entitled “Hand Pump Foamer” and was published Apr. 15, 2004 (Ser. No. 10/647,362, filed Aug. 25, 2003), which is incorporated herein by reference. In this embodiment, the flow controller provides a mechanism for controlling the flow of cleaning solution and pressurized air to the teat foam ring 10. The teat foam ring 10 may be connected to the output of the flow controller (not shown) using a male-to-male fitting (not shown), such as a conventional brass male-to-male nipple fitting.

In some applications, it may be desirable to provide the teat foam ring 10 with a mixing medium 23 to facilitate mixing of the pressurized cleaning solution and the pressurized air into a foam. If a mixing medium 23 is included, the mixing medium 23 may be located in the inlet 22 of the teat foam ring 10 (See FIG. 2). In this position, the mixing medium 23 helps to facilitate the development of foam within the teat foam ring 10. Alternatively, the mixing medium 23 may be located in the flow controller upstream from the teat foam ring 10. For example, the mixing medium 23 may be located either upstream or downstream from the flow control valve in the flow controller. The mixing medium 23 is not necessary in all applications and may be eliminated in some applications.

In the embodiment illustrated in the Figures, the bottom ring component 12 additionally defines the bottom 24, interior side wall 26 and exterior side wall 28 of the cleaning solution channel 30. The underside 32 of the upper ring component 14 defines the top 34 of the cleaning solution channel 30 when the teat foam ring 10 is assembled. The cleaning solution channel 30 is in fluid connection with both the cleaning solution inlet 22 and the extrusion slot 36. In an alternative embodiment, the bottom ring component 12 defines a v-shaped valley for the cleaning solution channel 30. In further alternative embodiments, the cleaning solution channel 30 may have any geometry providing suitable performance.

As perhaps best shown in FIG. 2, the extrusion slot 36 of the illustrated embodiment begins at the intersection of the interior side wall 26 and the top 34 of the cleaning solution channel 30 and extends upward to the top surface 38 of the teat foam ring 10. However, the extrusion slot 36 may be located essentially anywhere on the ring 10 provided that it produces the desired trajectory and velocity on the foam being expelled from the ring 10. In one embodiment, the ring 10 defines two radial surfaces 39 each extending between the inner circumferential wall 41 and the outer circumferential wall 43 of the ring 10. In this embodiment, the extrusion slot 36 exits the ring 10 on either of the radial surfaces 39.

When defined in the top surface 38 of the teat foam ring 10, the extrusion slot 36 may more readily be configured to dispense the foam such that it is supported atop the teat foam ring 10. However, the present invention is not limited to applications in which the foam is supported atop the ring 10.

In the illustrated embodiment, the geometry of the extrusion slot 36 is such that the slot 36 initially travels radially toward the center of the ring 10 and then angles upward toward a point elevated above the center of the ring 10. The slot 36 exits the ring 10 at a point on the upper surface 38 of the teat foam ring 10. The angle the slot 36 makes as the slot 36 exits the ring 10 is approximately 30 degrees from vertical toward the center of the ring 10, but this angle can be adjusted to accommodate, among other things, the foaming properties of the specific cleaning solution used. The extrusion slot 36 has a width of approximately 0.005 cm, but this measurement also can be adjusted to accommodate, among other things, the foaming properties of the specific cleaning solution used as well as the desired foam consistency and extrusion rate.

In the illustrated embodiment, pressurized cleaning solution in liquid form and compressed gas are delivered to the ring 10. The inlet 22 of the ring 10 contains a mixing medium 23. The liquid solution and pressurized air enter the ring 10 through the cleaning solution inlet 22 and flow past the mixing medium 23 and into the cleaning solution channel 30 around the interior circumference of the ring 10. The mixing medium 23 disrupts the flow of the pressurized liquid cleaning solution. The foam is then forced into the extrusion slot 36 from the cleaning solution channel 30 and out of the ring 10.

In those embodiments utilizing a flow controller, the flow controller may supply cleaning solution to the teat foam ring 10 in foam form. In such applications, compressed air and liquid cleaning solution may be combined in a mixing chamber 41 (which may contain a mixing medium) in the flow controller to form foam. This foam is then delivered to the teat foam ring 10 for expulsion. As an alternative, separate cleaning solution supply lines 40 and pressurized air supply lines 44 may be connected to the teat foam ring 10, for example, using a Y-fitting (not shown) to combine the cleaning solution and air immediately prior to entering the inlet 22.

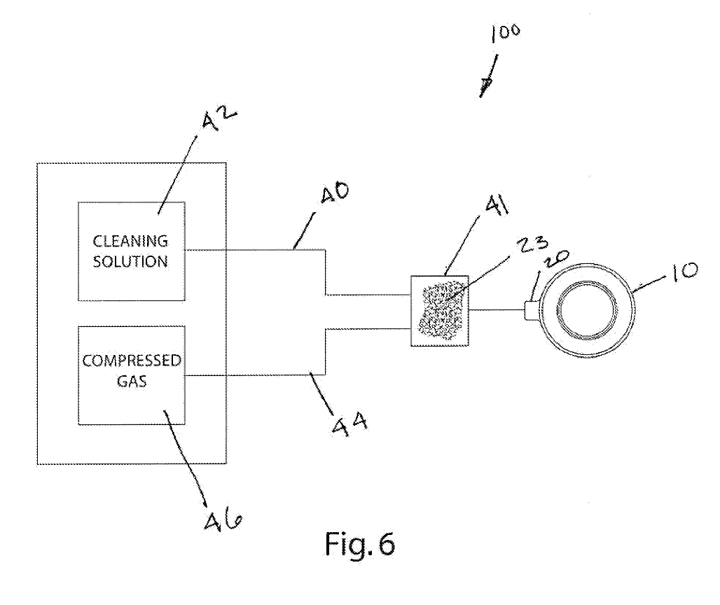

Operation of the overall system 100 is described in connection with FIG. 6. In the embodiment illustrated in FIG. 6, the system 100 generally includes a supply of cleaning solution 42, a supply of compressed gas 46 (or pressurized air) and a mixing chamber 41. The system 100 also includes a pair of supply lines 40 and 44 for delivering cleaning solution and air to the mixing chamber 41. More specifically, the system 100 includes a liquid supply line 40 connected between the cleaning solution supply 42 and the mixing chamber 41 and an air supply line 44 connected between the compressed gas supply 46 and the mixing chamber 41. The cleaning solution supply 42 may be essentially any apparatus capable of holding a supply of cleaning solution and conveying the cleaning solution to the mixing chamber 41. For example, the cleaning solution supply 42 may be a conventional teat cleaning solution distribution system. Similarly, the compressed gas supply 46 may be essentially any apparatus capable producing and/or storing a compressed gas and conveying the compressed gas to the mixing chamber 41. For example, the compressed gas supply 46 may be a conventional air compressor. During use, the compressed gas and liquid cleaning solution combine in the mixing chamber 41 and are transformed into foam. The mixing chamber 41 may contain a mixing medium 23 to facilitate the transformation to foam. The mixing chamber 23 may be part of a flow controller, may be a freestanding unit, or may be incorporated into the teat foam ring 10 in the cleaning solution inlet 22 of the ring 10. Foam is then delivered to the cleaning solution channel 30 of the ring 10 through the cleaning solution inlet 22. The foam is then expelled out of the extrusion slot 36.

In one embodiment, the geometry of the extrusion slot 36 imparts a trajectory on the foam such that the expelled foam masses to form a “cone of foam” on the upper surface 38 of the ring 10. The geometry of the extrusion slot 36 may be varied to control the size and shape of the foam cone. Once an appropriate amount of foam has amassed on the upper surface 38 of the ring 10, the teat foam ring 10 may be moved upwardly around a teat so that the teat is moved through the cone of foam. As the teat foam ring 10 is removed, the foam clings to and covers the surface of the teat, thereby disinfecting the teat. The process may be repeated to treat additional teats.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A teat foam ring comprising:
an inner circumferential surface having an axis, said inner circumferential surface defining an opening of sufficient diameter to receive a teat;
an outer circumferential surface;
first and second radial surfaces;
a cleaning solution inlet;
a cleaning solution channel in fluid connection with said cleaning solution inlet; and
an extrusion slot, said extrusion slot in fluid connection with said cleaning solution channel and extending out to said first radial surfaces in a direction angled toward said axis, whereby foam discharged from said extrusion slot builds up on said first radial surface in a cone over said opening.

2. The ring of claim 1 wherein said cleaning solution inlet is disposed on said outer circumferential surface.

3. The ring of claim 2 further comprising a mixing medium contained within the ring.

4. The ring of claim 3 wherein said mixing medium is located in said inlet.

5. The ring of claim 4 wherein said cleaning solution channel circles the entire circumference of said ring.

6. The ring of claim 5 wherein said extrusion slot circles the entire circumference of said ring continuously.

7. The ring of claim 5 wherein said extrusion slot is discontinuous over the circumference of said ring.

8. A teat foam ring comprising:
a ring-shaped component having an upper surface and defining a central opening of sufficient diameter to receive a teat, said upper surface generally surrounding said central opening, said ring-shaped component including a cleaning solution inlet, said ring-shaped component defining an internal cleaning solution channel in fluid connection with said cleaning solution inlet, said-shaped component defining an extrusion slot, said extrusion slot opening into said upper surface and angling toward the center of said ring, whereby foam discharged from said extrusion slot forms a cone over said opening supported by said upper surface.

9. The ring of claim 8 further comprising a mixing medium contained within the ring.

10. The ring of claim 9 wherein said mixing medium is located in said inlet.

11. The ring of claim 10 wherein said cleaning solution channel circles the entire circumference of said ring.

12. A system for applying cleansing foam comprising:
a liquid cleaning solution supply source;
a compressed gas supply source;
a mixing chamber;
a liquid supply line in fluid connection with said liquid cleaning solution supply source and said mixing chamber;
a compressed gas supply line in pressurized fluid connection with said compressed gas supply source and said mixing chamber; and
a foam emitting ring in fluid connection with said mixing chamber, said ring defining an central opening of sufficient size to receive a teat, said ring having an upper surface and defining an extrusion slot opening into said upper surface and angling toward the center of said ring, whereby foam discharged from said extrusion slot forms a cone over said opening supported by said upper surface.

13. A system as defined in claim 12 wherein said mixing chamber is configured to promote the generation of foam when the liquid cleaning solution and compressed gas converge in said mixing chamber.

14. A system as defined in claim 13 further comprising a mixing medium.

15. A system as defined in claim 14 wherein said mixing medium is located in said mixing chamber.

16. A system as defined in claim 15 wherein said ring attaches directly to a flow controller.

17. A system as defined in claim 16 wherein said flow controller has a mixing chamber.

18. A system as defined in claim 17 wherein said liquid supply line is in fluid connection with said liquid cleaning solution supply source and said flow controller and said compressed gas supply line is in pressurized fluid connection with said compressed gas supply source and said flow controller.

19. A system as defined in claim 16 wherein said ring comprises:
an outer circumferential surface;
first and second radial surfaces;
a cleaning solution inlet located on said outer circumferential surface;
a cleaning solution channel in fluid connection with said cleaning solution inlet; and
said extrusion slot in fluid connection with said cleaning solution channel.

20. A system as defined in claim 19 wherein said mixing medium is located in said inlet.
